(19) United States
(12) Patent Application Publication
(10) Pub. No.: US 2026/0016153 A1
(43) Pub. Date: Jan. 15, 2026

(54) LIGHTING DEVICE AND AUDIO OUTPUT DEVICE INCLUDING A TWIST LOCK ASSEMBLY

(71) Applicant: MILWAUKEE ELECTRIC TOOL CORPORATION, Brookfield, WI (US)

(72) Inventors: Jeffrey L. Spenner, Germantown, WI (US); John F. Koebl, Menomonee Falls, WI (US)

(21) Appl. No.: 19/266,302

(22) Filed: Jul. 11, 2025

Related U.S. Application Data
(60) Provisional application No. 63/670,158, filed on Jul. 12, 2024.
(60) Provisional application No. 63/759,740, filed on Feb. 18, 2025.

(51) Int. Cl. F21V 33/00; F21Y 115/10; H01M 50/251; H04R 1/02

(52) U.S. Cl. CPC F21V 33/0084; H01M 50/251; H04R 1/026; H04R 1/028; F21Y 2115/10

(57) ABSTRACT

A product for use with a storage unit includes a body, an output element supported by the body, a rotating disc coupled to the body for rotation therewith, and a base configured to engage the storage unit. The rotating disc includes a first locking member, and the base includes a second locking member. The rotating disc is movable relative to the base between an engaged position, in which the first locking member engages the second locking member such that the base rotates with the rotating disc, and a disengaged position, in which the first locking member disengages the second locking member such that the rotating disc is rotatable relative to the base.

### CROSS-REFERENCE TO RELATED APPLICATIONS

This application claims priority to U.S. Provisional Patent Application No. 63/759,740, filed on Feb. 18, 2025, and to U.S. Provisional Patent Application No. 63/670,158, filed on Jul. 12, 2024, the entire contents of both of which are incorporated by reference herein.

### BACKGROUND

The present disclosure relates to a lighting device, audio output device, or other product with a mechanism to detachably couple the lighting device or other device to a storage device, unit, or container.

### SUMMARY

In some aspects, the techniques described herein relate to a product for use with a storage unit. The product includes a body, an output element supported by the body, a rotating disc coupled to the body for rotation therewith, and a base configured to engage the storage unit. The rotating disc includes a first locking member, and the base includes a second locking member. The rotating disc is movable relative to the base between an engaged position, in which the first locking member engages the second locking member such that the base rotates with the rotating disc, and a disengaged position, in which the first locking member disengages the second locking member such that the rotating disc is rotatable relative to the base.

In some aspects, the techniques described herein relate to a product, wherein the base includes a first engagement feature configured to align with a second engagement feature in a receptacle of the storage unit.

In some aspects, the techniques described herein relate to a product, wherein when the rotating disc is in the engaged position, the product is rotatable in a first direction to align the first engagement feature with the second engagement feature, thereby securing the base in the receptacle, and wherein when the rotating disc is in the engaged position, the product is rotatable in a second direction opposite the first direction to misalign the first engagement feature from the second engagement feature, thereby allowing the base to be removable from the receptacle.

In some aspects, the techniques described herein relate to a product, wherein the first locking member includes a first plurality of teeth and the second locking member includes a second plurality of teeth configured to mesh with the first plurality of teeth.

In some aspects, the techniques described herein relate to a product, wherein the first locking member includes a first material and the second locking member includes a second material, and wherein the first material engages the second material when in the engaged position to produce a frictional force between the rotating disc and the base for co-rotation.

In some aspects, the techniques described herein relate to a product, further including an abutment plate coupled to the base by a fastener, and wherein the rotating disc abuts against the abutment plate when in the disengaged position.

In some aspects, the techniques described herein relate to a product, further including a spring positioned between the rotating disc and the base, and wherein the spring biases the rotating disc toward the disengaged position.

In some aspects, the techniques described herein relate to a product, wherein the product is a lighting device and the output element is a light-emitting diode to provide illumination to a workspace.

In some aspects, the techniques described herein relate to a product, wherein the product is an audio output device and the output element is a speaker.

In some aspects, the techniques described herein relate to a product for use with a storage unit. The product includes a body, a base configured to engage the storage unit, an output element supported by the body, and a hook movably coupled to the base. The body includes a first end and a second end opposite the first end. The hook is movable relative to the base between a stored position, in which the hook is received in the base, and an extended position, in which the hook extends outwardly from the base and is configured to couple to a support structure.

In some aspects, the techniques described herein relate to a product, wherein the base includes a first engagement feature configured to align with a second engagement feature in a receptacle of the storage unit to secure the product in the receptacle.

In some aspects, the techniques described herein relate to a product, further including a battery receptacle positioned at the first end of the body, and wherein the first engagement feature and the hook are both positioned on the second end of the body.

In some aspects, the techniques described herein relate to a product, wherein the hook secures the product to a support structure in a first orientation relative to ground, and wherein the first engagement feature secures the product to the storage unit in a second orientation relative to ground that is different from the first orientation.

In some aspects, the techniques described herein relate to a product for use with a storage unit. The product includes a body, a battery receptacle, an output element supported by the body, and a base rotatably couplable to the storage unit. The body includes a first end and a second end opposite the first end. The battery receptacle is positioned at the first end of the body and is configured to receive a battery pack. The output element is configured to be powered by the battery pack coupled to the battery receptacle. The base includes a first engagement feature configured to align with a second engagement feature in a receptacle of the storage unit. The product is rotatable in a first direction to align the first engagement feature with the second engagement feature, thereby securing the base in the receptacle. Additionally, the product is rotatable in a second direction opposite the first direction to misalign the first engagement feature from the second engagement feature, thereby allowing the base to be removable from the receptacle.

In some aspects, the techniques described herein relate to a product, wherein the first engagement feature includes a plurality of protrusions extending radially outward from the base. Each protrusion includes a plurality of flats having progressively increasing heights that are arranged to form a ridgeline that runs along top surfaces of the protrusions.

Other features and aspects of the invention will become apparent by consideration of the following detailed description and accompanying drawings.

### BRIEF DESCRIPTION OF THE DRAWINGS

FIG. 1 is a perspective view of a lighting device including a twist lock assembly selectively coupled to a storage unit.

FIG. 2 is a perspective view of a light panel of the lighting device of FIG. 1.

FIG. 3 is a front view of the light panel of the lighting device of FIG. 1.

FIG. 4 is a first side view of the lighting device of FIG. 1.

FIG. 5 is a rear view of the lighting device of FIG. 1.

FIG. 6 is a second side view of the lighting device of FIG. 1.

FIG. 7 is a perspective view of the twist lock assembly of the lighting device of FIG. 1.

FIG. 8 is a cross-sectional, perspective view of the twist lock assembly through section line 8-8 of FIG. 7.

FIG. 9 is a bottom view of the lighting device of FIG. 1.

FIG. 10 is a cross-sectional view of the lighting device through section line 10-10 of FIG. 1.

FIG. 11 is a cross-sectional view of the lighting device through section line 11-11 of FIG. 1.

FIG. 12A is a cross-sectional view of the twist lock assembly of FIG. 7.

FIG. 12B is a cross-sectional view of another twist lock assembly for use with the lighting device of FIG. 1.

FIG. 12C is a cross-sectional view of another twist lock assembly for use with the lighting device of FIG. 1.

FIG. 12D is a cross-sectional view of another twist lock assembly for use with the lighting device of FIG. 1.

FIG. 13 is a perspective view of a puck without a twist lock assembly for use with the lighting device of FIG. 1.

FIG. 14 is a perspective view of an audio output device including a base to couple to a storage unit.

FIG. 15 is a side view of the audio output device of FIG. 14 in a vertical orientation.

FIG. 16 is a side view of the audio output device of FIG. 14 in a horizonal orientation.

FIG. 17 is another side view of the audio output device of FIG. 14 in the vertical orientation.

FIG. 18 illustrates the audio output device of FIG. 14 mounted to a support structure.

FIG. 19 is a perspective view of a portion of the audio output device of FIG. 14, illustrating the base.

FIG. 20 illustrates the audio output device of FIG. 14 coupled to a storage unit.

FIG. 21 is a bottom view of the audio output device of FIG. 14.

FIG. 22 illustrates the audio output device of FIG. 14 hanging from a support structure.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

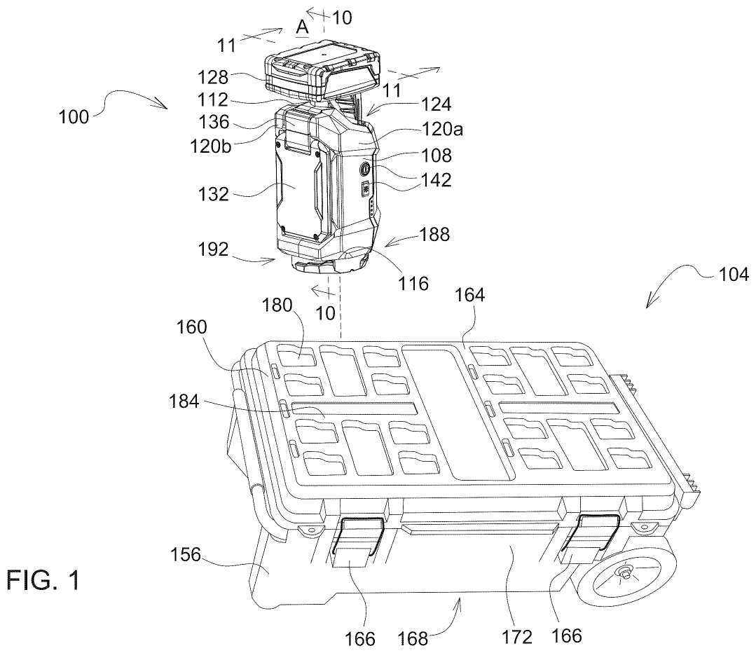

FIGS. 1 and 4-6 illustrate a product 100 that may be selectively coupled to a storage unit 104. In the illustrated embodiment, the product 100 is a lighting device. In other embodiments, the product 100 may be an audio output device or speaker, a fan, or any other device. The product 100 includes a body 108 having a first end 112 and a second end 116 opposite the first end 112. The body 108 defines an axis A extending through the first end 112 and the second end 116. The body 108 is formed from two clamshell halves 120a, 120b. A battery receptacle 124 is positioned at the first end 112 of the body 108. The battery receptacle 124 is configured to receive a battery pack 128. The battery pack 128 may be a removeable and rechargeable 12-volt battery pack and include (3) Lithium-ion battery cells. In other constructions, the battery pack 128 may include fewer or more battery cells, different chemistries, and/or different output voltages. The illustrated battery pack 128 is insertable into the battery receptacle 124 along the axis A. When connected to the battery receptacle 124, the battery pack 128 provides power to an output element 132. In other embodiments, the product 100 may be powered by other types of battery packs or by a dedicated battery inside the body 108.

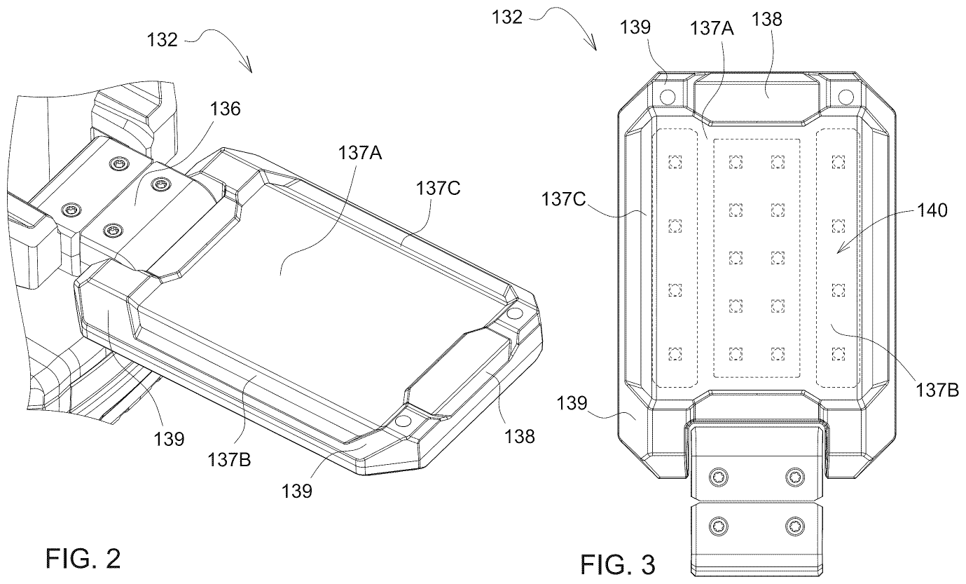

In the illustrated embodiment, the output element 132 is a light panel including one or more light-emitting diodes (LEDs) to provide illumination to a workspace. The light panel is coupled to and supported by the body 108. The illustrated light panel is moveable (e.g., pivotable) relative to the body 108 via a hinge 136 between a closed position, as seen in FIG. 1, and an open position, as seen in FIG. 2, to provide light to the workspace. When in the open position, the light panel may also rotate relative to the hinge 136 to change an output orientation of the light panel. In other embodiments, the output element 132 may alternatively or additionally include a different lighting element that is fixed (i.e., stationary) on the body 108. In still other embodiments, the output element 132 may be a different type of output element (e.g., fan blades, a speaker, etc.) depending on the product 100.

As shown in FIG. 2, the illustrated light panel includes three (3) panes. In other embodiments, the light panel may include any number of panes. The light panel includes a first pane 137A, a second pane 137B, and a third pane 137C. The first pane 137A is positioned between the second pane 137B and the third pane 137C. In the illustrated embodiment, the first pane 137A is larger (e.g., wider) than the second pane 137B and the third pane 137C. In other embodiments, the panes 137A, 137B, 137C may be generally the same size. The second pane 137B and the third pane 137C extend from the first pane 137A at an angle. The angle may be, for example, between 10 degrees and 50 degrees. The second pane 137B and the third pane 137C allow light from the light panel to project from the light panel at a wider angle, thereby providing light to additional area of the workspace. The panes 137A-137C are surrounded by a light panel bezel 138. The light panel bezel 138 includes curvatures 139 to accommodate the second pane 137B and the third pane 137C extending at the angle from the first pane 137A.

As shown in FIG. 3, the light panel includes a lens 140 that covers the LEDs. The lens 140 also defines the panes 137A-137C. In the illustrated embodiments, the lens 140 may be a diffused lens 140. The diffused lens 140 is configured to spread (e.g., diffuse) light beams from the LEDs about the workspace. The diffused lens 140 may reduce the intensity of the light beams extending from the LEDs to the workspace.

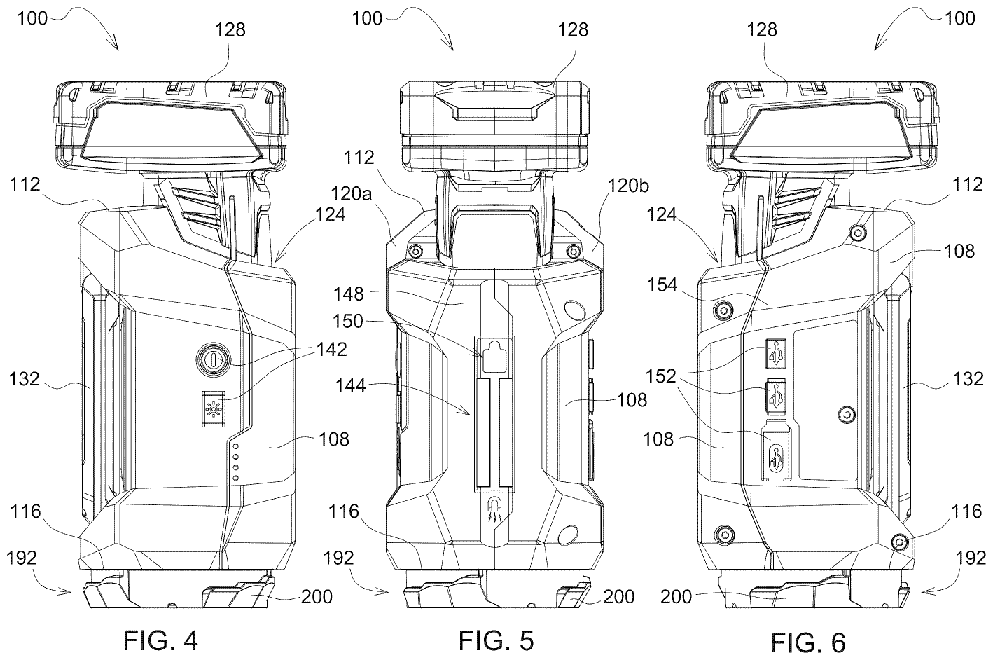

Referring back to FIGS. 1 and 4, the illustrated product 100 also includes a plurality of buttons 142 (FIG. 4) positioned on the body 108 to control operation of the product 100. For example, the buttons 142 may turn the product ON and OFF, change a power setting or mode (e.g., high, medium, low, etc.) of the output element 132, and the like. In the illustrated embodiment, the buttons 142 are push buttons. In other embodiments, the product 100 may include other suitable actuators, such as a rotatable dial, a slider switch, and the like.

As shown in FIG. 5, the illustrated product 100 also includes a magnet 144. The magnet 144 is positioned on a side 148, or rear, of the body 108 opposite the output element 132. In the illustrated embodiment, the product 100 includes two magnets 144. In other embodiments, the product 100 may include fewer or more magnets. The magnets 144 allow the product 100 to be magnetically coupled to a ferrous surface (e.g., workbench, wall, power tool, etc.), when not coupled to the storage unit 104.

The illustrated product 100 also includes a slot 150. The slot 150 is formed on the side 148 of the body 108 adjacent the magnets 144. The slot 150 is configured to receive a nail, hook, or other suitable support structure to hang the product 100 from the support structure. In other embodiments, the magnets 144 and/or the slot 150 may be located elsewhere on the body 108 or may be omitted.

As shown in FIG. 6, the illustrated product 100 includes one or more ports 152. The ports 152 are positioned on a side 154 of the body 108 opposite the buttons 142. In the illustrated embodiment, the ports 152 may include both output ports and input ports. The output ports 152 allow an external device (e.g., cellular device, power tool, etc.) to receive power from the battery pack 128. The input ports 152 allow the battery pack 128 to be charged by an external device and/or allow an external device to power the output element 132. In the illustrated embodiment, the ports 152 are USB-type ports. In other embodiments, the ports 152 may be different types of ports, may be located elsewhere on the body 108, or may be omitted. The illustrated product 100 is one example of a lighting device. In other embodiments, the lighting device may have other configurations or include additional features and components.

With reference to FIG. 1, in the illustrated embodiment, the storage unit 104 may be part of the PACKOUT modular storage system sold by Milwaukee Tool. In other embodiments, the product 100 may be coupled to any type of wall mount, dolly, or toolbox used to hold objects. The illustrated storage unit 104 includes a storage base 156 coupled to a lid 160 via hinges 164. The lid 160 is moveable relative to the storage base 156 between a closed position and an open position. A plurality of latches 166 secure the lid 160 to the storage base 156 in the closed position. The storage base 156 includes a lower surface 168 and a plurality of walls 172 extending up from the lower surface 168, thereby defining a cavity (not shown). The cavity is configured to receive a variety of components (e.g., power tools, drill bits, fasteners, etc.). The lid 160 includes a plurality of receptacles 180. Each receptacle 180 includes a plurality of projections 184 extending over a portion of the receptacle 180. The projections 184, or engagement features, are configured to axially secure the product 100 to the storage unit 104, as described in further detail later. Although the illustrated storage unit 104 includes multiple receptacles 180, in other embodiments, the storage unit 104 may only include a single receptacle 180.

The product 100 includes a twist lock assembly 188 for selectively securing the body 108 to the storage unit 104. In particular, the twist lock assembly 188 allows the product 100 to be received in and secured to one of the receptacles 180 of the storage unit 104. The twist lock assembly 188 axially secures the body 108 to the storage unit 104 to inhibit separation of the product 100 from the storage unit 104, while allowing the body 108 to be freely rotated relative to the storage unit 104 around the axis A. For example, in some embodiments, the body 108 may be rotated 360 degrees around the axis A relative to the storage unit 104. In other embodiments, the body 108 may be limited to less than 360 degrees about the axis A. The twist lock assembly 188 also includes a mechanism that selectively inhibits free rotation of the body 108 relative to the storage unit 104, allowing the product 100 to be unsecured and axially separated from the storage unit 104.

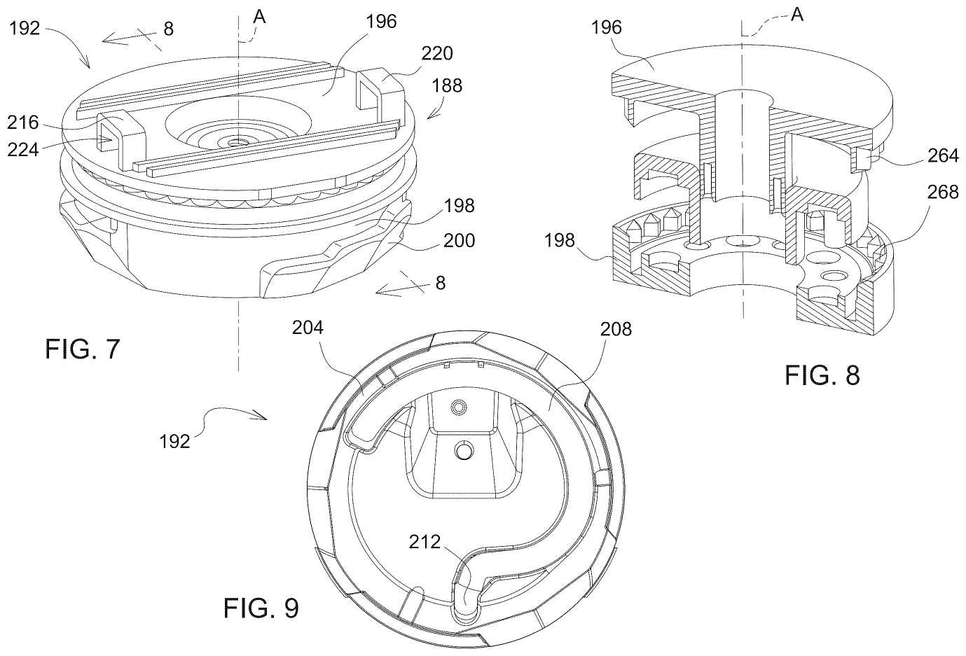

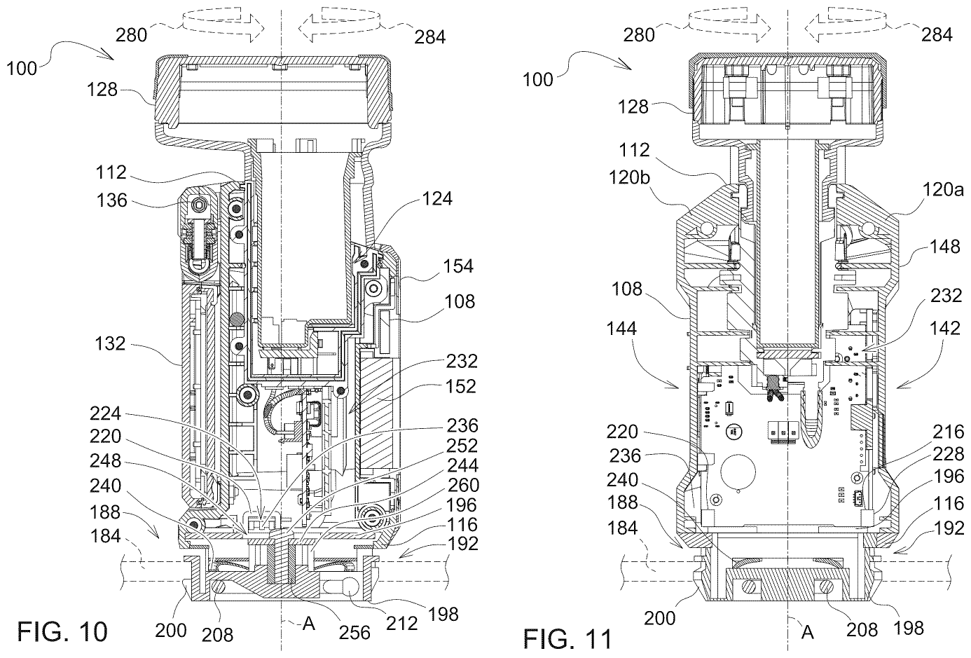

With reference to FIGS. 7-8, the product 100 includes a puck 192 that houses the twist lock assembly 188. The puck 192 is positioned at the second end 116 of the body 108. The illustrated twist lock assembly 188 includes a rotating disc 196 and a base 198. The rotating disc 196 defines a central axis that is co-axial with the axis A of the body 108. The rotating disc 196 is positioned between the base 198 and the body 108. The body 108 is selectively coupled to the base 198 by the rotating disc 196. The puck 192 includes protrusions 200 extending radially outward from the base 198. The protrusions 200 are configured to align with the projections 184 (FIGS. 10-11) of the storage unit 104 to axially lock the product 100 to the storage unit 104 in the receptacle 180. As seen in FIG. 9, a hook 208 may be positioned on a bottom 204 of the base 198. The hook 208 may pivot about a pivot joint 212 to an open position. In the open position, the hook 208 allows the product 100 to be hung from an object (e.g., workbench, ladder, etc.).

With reference to FIGS. 7 and 10-11, the rotating disc 196 includes a first handle 216 and a second handle 220 extending from the rotating disc 196. Each handle 216, 220 defines a D-shaped aperture 224. The first clamshell half 120a includes a first arm 228 extending internally into a cavity 232 of the body 108. The second clamshell half 120b includes a second arm 236 extending internally into the cavity 232 of the body 108. As the first clamshell half 120a is coupled to the second clamshell half 120b during construction, the first arm 228 is received into the first handle 216 and the second arm 236 is received into the second handle 220. As such, the body 108 is fixedly (i.e., non-movably) coupled to the rotating disc 196.

With reference to FIGS. 10-11, the twist lock assembly 188 also includes a spring 240 positioned between the rotating disc 196 and the base 198. The spring 240 biases the rotating disc 196 away from the base 198. In the illustrated embodiment, the spring 240 is a singular spring extending annularly around the axis A. In other embodiments, the twist lock assembly 188 may include a plurality of springs positioned annularly around the axis A. The illustrated spring 240 is a coil spring. In other embodiments, the spring 240 may be other suitable types of spring elements.

The illustrated twist lock assembly 188 also includes an abutment plate 244. The abutment plate 244 axially secures the rotating disc 196 to the base 198 when the spring 240 biases the rotating disc 196 away from the base 198. The abutment plate 244 is positioned inside of an inner cavity 248 of the rotating disc 196 opposite from the base 198. A fastener 252 (e.g., a bolt, etc.) couples the abutment plate 244 to a hub 256 of the base 198. A portion 260 of the rotating disc 196 abuts the abutment plate 244 to limit a distance the rotating disc 196 is biased away from the base 198 by the spring 240. The rotating disc 196 may rotate relative to the abutment plate 244 when the spring 240 biases the rotating disc 196 away from the base 198.

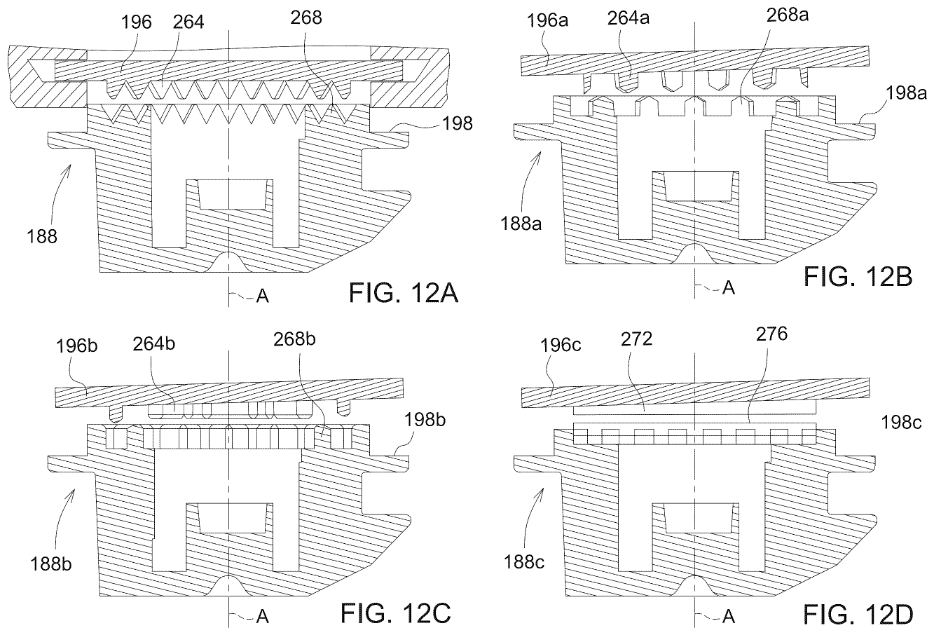

With reference to FIG. 12A, the rotating disc 196 includes a first locking member that selectively engages with a second locking member of the base 198. In the illustrated embodiments, the first locking member includes a first set of teeth 264 and the second locking member includes a second set of teeth 268 configured to mesh with the first set of teeth 264. In the illustrated embodiment, both the first set of teeth 264 and the second set of teeth 268 extend parallel to the axis A. Each tooth 264, 268 forms a triangular prism shape and is configured to be received into a corresponding valley between adjacent teeth of the opposite set of teeth 264, 268. When the first set of teeth 264 meshes with the second set of teeth 268, the rotating disc 196 and the base 198 are coupled together for co-rotation.

FIG. 12B illustrates another example of a twist lock assembly 188a that can be part of the product 100. The twist lock assembly 188a is similar to the twist lock assembly 188 and includes a rotating disc 196a having a first set of teeth 264a and a base 198a having a second set of teeth 268a. In the illustrated embodiment, however, the teeth 264a, 268a are generally trapezoidal shaped. Rectangular apertures are formed between adjacent teeth 264a, 268a to receive the opposing set of teeth 264a, 268a.

FIG. 12C illustrates another example of a twist lock assembly 188b that can be part of the product 100. The twist lock assembly 188b is similar to the twist lock assembly 188 and includes a rotating disc 196b having a first set of teeth 264b and a base 198b having a second set of teeth 268b. In the illustrated embodiment, however, the teeth 264b, 268b extend perpendicular to the axis A.

FIG. 12D illustrates another example of a twist lock assembly 188c that can be part of the product 100. The twist lock assembly 188c is similar to the twist lock assembly 188 and includes a rotating disc 196c and a base 198c. In the illustrated embodiment, however, the rotating disc 196c and the base 198c are selectively coupled together via frictional engagement, rather than by teeth. For example, the rotating disc 196c includes a first locking member 272 formed of a first material, and the base 198c includes a second locking member 276 formed a second material. The second material faces the first material. The first material may be the same as the second material. In other embodiments, the first material may be different from the second material. The first material and the second material may be any material with a suitable amount of static friction (e.g., sandpaper, rubber, etc.) to rotationally couple the rotating disc 196c to the base 198c. When the first locking member 272 of the rotating disc 196c is in contact with the second locking member 276 of the base 198c, a frictional force between the first material and the second material is produced. When a rotational force applied to the body 108 of the product 100 by a user is less than the frictional force, the rotating disc 196c may co-rotate with the base 198.

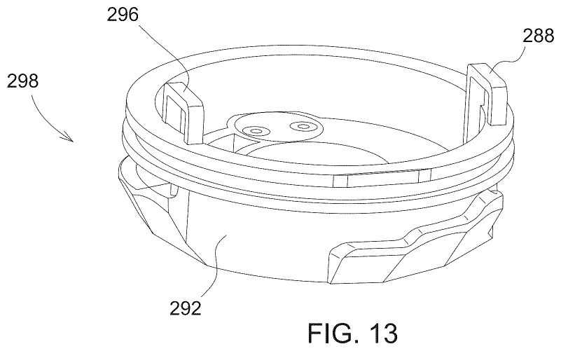

FIG. 13 illustrates another example of a puck 288 that can be part of the product 100. The puck 288 is similar to the puck 192 except that the puck 288 does not include the twist lock assembly 188. In such a construction, the body 108 of the product 100 is non-movably coupled to a base 292 of the puck 288 via handles 296, 298.

Referring back to FIGS. 1, 10, and 11, to couple the product 100 to the storage unit 104, the puck 192 is aligned and inserted into one of the receptacles 180 in the storage unit 104. When the puck 192 is inserted into the receptacle 180, the projections 184 on the receptacle 180 are misaligned from the protrusions 200 of the puck 192. The user may apply a downward force on the product 100 (e.g., on the second end 116 of the body 108 and/or on the battery pack 128) along the axis A and towards the puck 192, thereby placing the rotating disc 196 and the base 198 in an engaged position. In the engaged position, the first locking member on the rotating disc 196 and the second locking member on the base 198 are engaged. The user may then apply a rotational force to the product 100 in a first direction 280 (while still applying the downward force), thereby rotating the body 108 and the base 198 together. By rotating the base 198 in the receptacle 180, the protrusions 200 extending from the base 198 may align with the projections 184. Due to the overlap of the projections 184 and the protrusions 200, the product 100 is axially secured to the storage unit 104. The user may then release the applied force, thereby putting the body 108 and the base 198 in a disengaged position. The user may transport the storage unit 104 to any desired location without the product 100 disconnecting from the lid 160.

In the disengaged position, the spring 240 biases the rotating disc 196 away from the base 198, such that the first locking member and the second locking member are not engaged. The body 108 of the product 100 and the rotating disc 196 may then freely move (e.g., rotate) relative to the base 198 in any direction (e.g., 360 degrees) around the axis A. In the illustrated embodiment, the user may also pivot the output element 132 (e.g., the light panel) to the open position and shine light on a workspace in a desired direction.

To remove the product 100 from the storage unit 104, the user applies the downward force to the product 100 along the axis A and toward the puck 192. The user then rotates the product 100 in a second direction 284 opposite the first direction 280. The protrusions 200 may then be misaligned from the projections 184 of the receptacle 180, thereby allowing the removal of the base 198 from the receptacle 180.

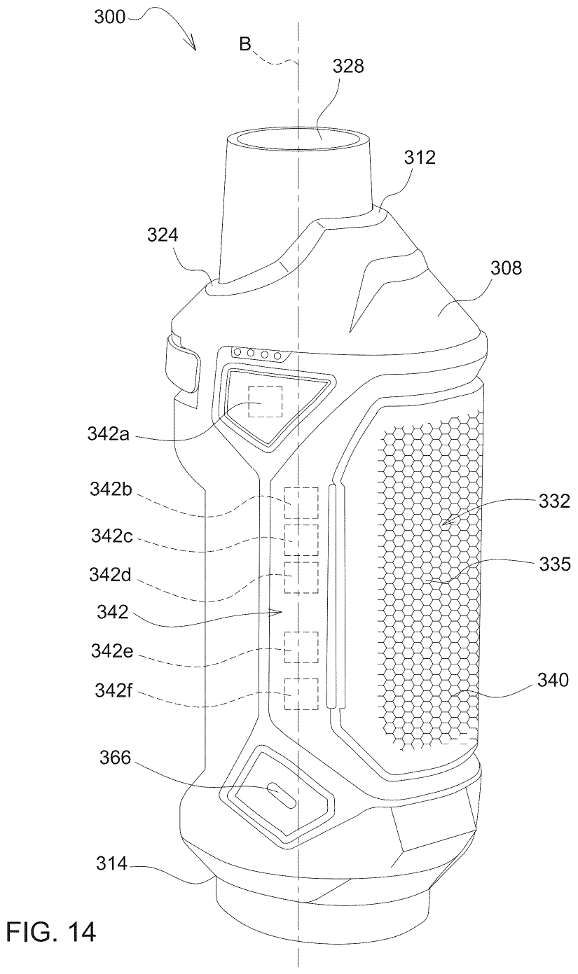

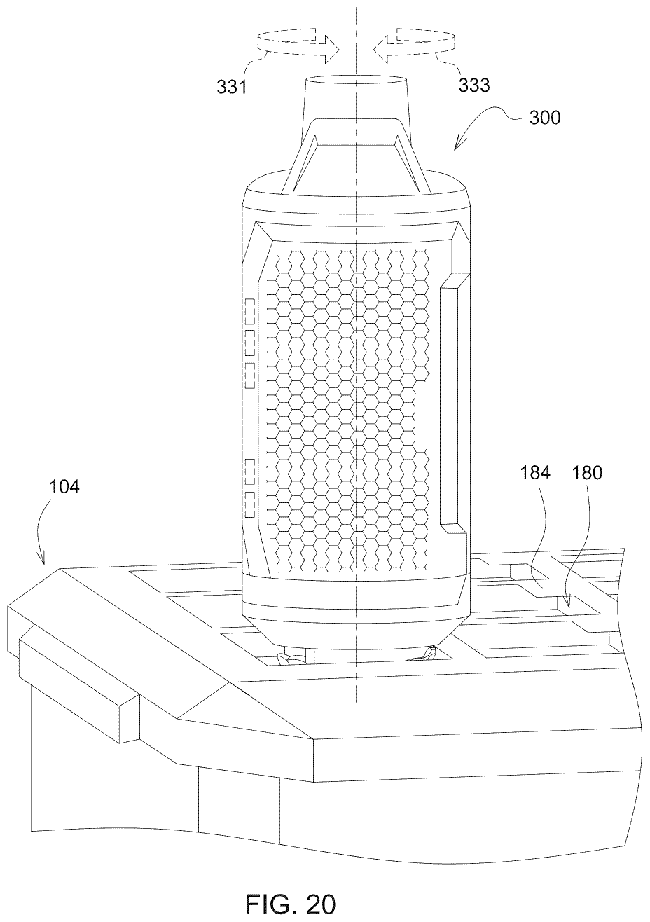

FIGS. 14-16 illustrate a product 300 according to another embodiment of the invention. Similar to the product 100, the product 300 may be selectively coupled to a storage unit, such as the storage unit 104 (FIGS. 1 and 20). The illustrated product 300 is an audio output device. The audio output device 300 may be a portable, wireless device. In some embodiments, the audio output device 300 may receive a wireless signal from an external device using Bluetooth®, Bluetooth® low energy (BLE), near field communication (NFC), Wi-Fi, cellular data, or other wireless communication schemes. For example, the wireless signal may include sound data, control inputs, notifications, etc. In some embodiments, the audio output device 300 may transmit audio signals and relay wireless signals from the external device to a second audio output device.

The audio output device 300 includes a body 308 having a first end 312 and a second end 314 opposite the first end 312. The body 308 defines an axis B extending through the first end 312 and the second end 314. A battery receptacle 324 is positioned at the first end 312 of the body 308. The battery receptacle 324 is configured to receive a battery pack 328, which may be similar to the battery pack 128 described above. The battery pack 328 is insertable into the battery receptacle 324 along the axis B. When connected to the battery receptacle 324, the battery pack 328 provides power to an output element 332. In other embodiments, the audio output device 300 may be powered by other types of battery packs or by a dedicated battery inside the body 308.

In the illustrated embodiment, the output element 332 is at least one speaker. The speakers may include a mid-range speaker, a tweeter, a woofer, a subwoofer, a supertweeter, multiple tweeters, or any combination thereof. In other embodiments, the output element 332 may include other types of speakers. The body 308 includes a speaker grill 335 adjacent the speakers. The speaker grill 335 includes a plurality of apertures 340 that allow sound to be emitted from the speakers. In some embodiments, the speaker grill 335 may be made of metal or plastic and is configured to inhibit debris from contacting the speaker 330. In some embodiments, the speaker grill 335 and the speaker occupy a surface area of the audio output device in a 1:1 ratio. Alternatively, in some embodiments, the speaker grill 335 and the speaker occupy a surface area of the audio output device in a 3:2 ratio. In some embodiments, the audio output device 300 may include one, two, three, or four speakers.

As shown in FIG. 14, the illustrated audio output device 300 also includes a plurality of buttons 342 positioned on the body 308 to control operation of the audio output device 300. For example, the plurality of buttons 342 may include a power actuator 342a, a play actuator 342b, a volume increase actuator 342c, a volume decrease actuator 342d, a Bluetooth® actuator 342e, and a daisy chain actuator 342f. The buttons 342 form a user interface. In the illustrated embodiment, the buttons 342 are push buttons. In other embodiments, the audio output device 300 may include other suitable actuators, such as rotatable dials, slider switches, and the like.

The illustrated audio output device 300 also includes a charging port 366. In the illustrated embodiment, the charging port 366 is positioned on the body 308 adjacent the user interface. In some embodiments, the charging port 366 is a USB-C charging port that provides power to the battery pack 328. The charging port 366 may also or alternatively provide power to an external device from the battery pack 328. In other embodiments, the charging port 366 may be a different type of port. Additionally or alternatively, the charging port 366 may be located elsewhere on the body 308.

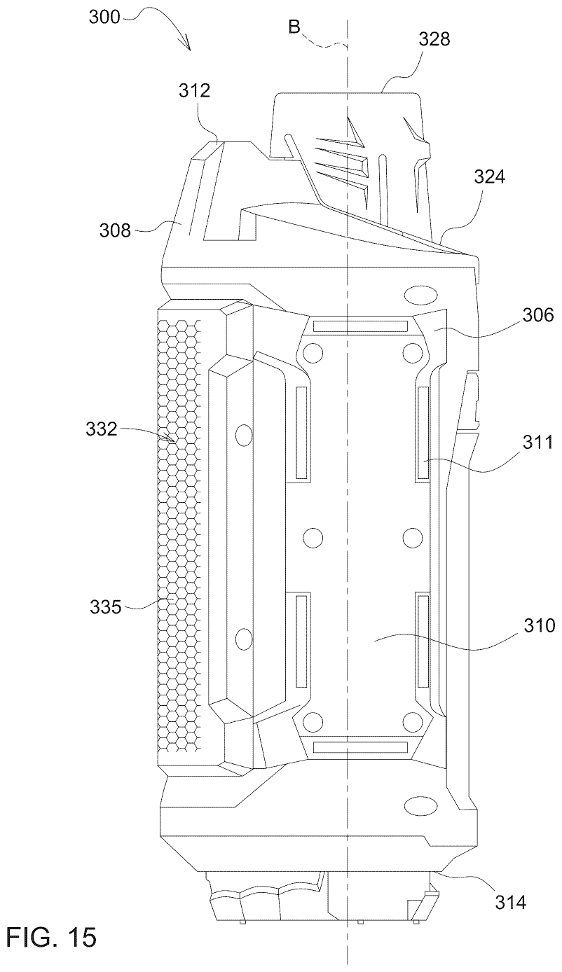

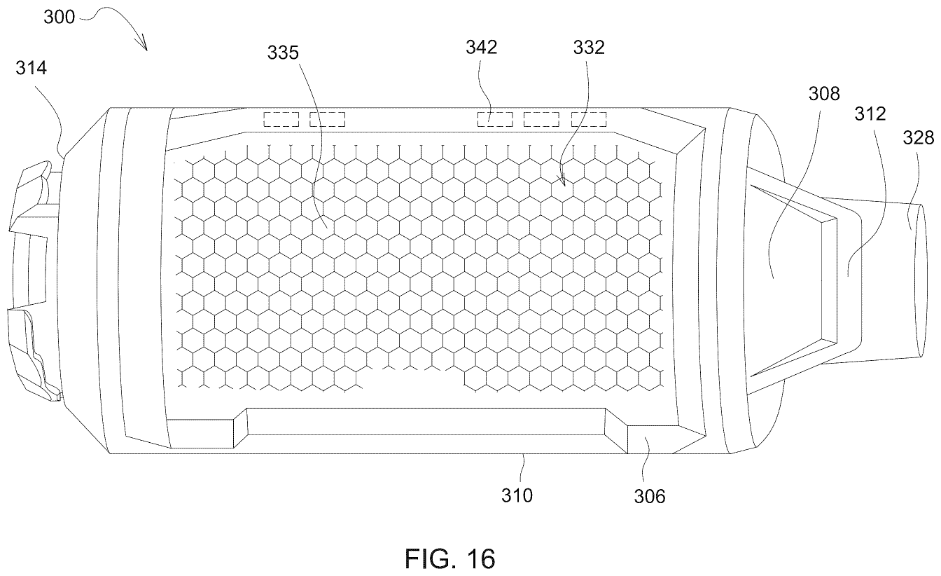

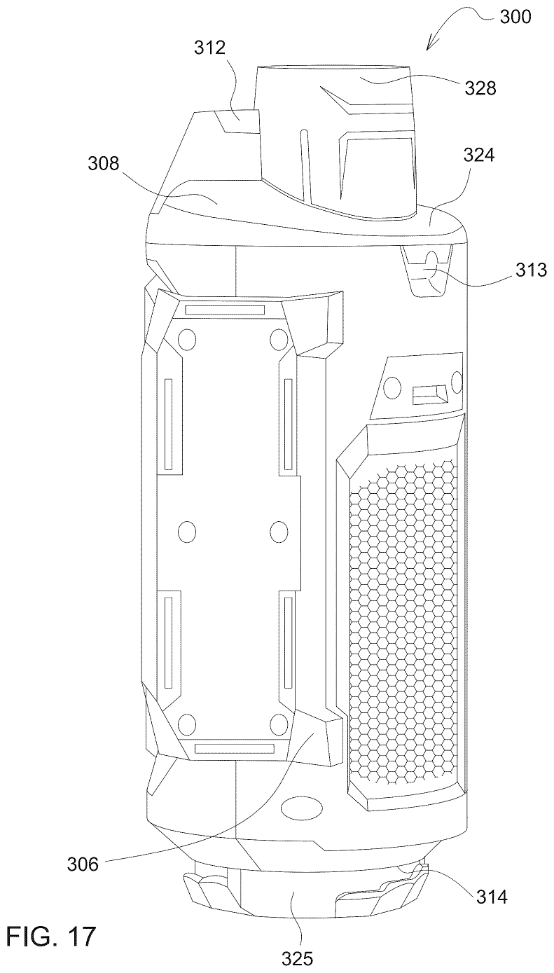

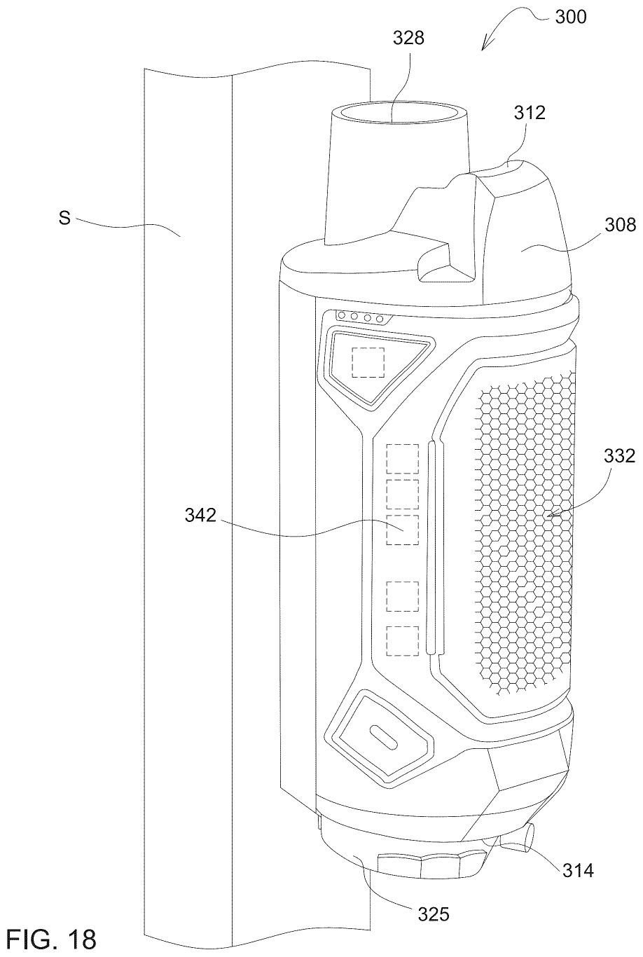

Referring now to FIGS. 15 and 16, the audio output device 300 also includes a lateral support structure 306 coupled to the body 308. The illustrated lateral support structure 306, or shoe, is generally rectangular and extends parallel to the axis B. The lateral support structure 306 is positioned on a side of the body 308 opposite the buttons 342. As such, the speaker grill 335 and speakers are positioned between the buttons 342 and the lateral support structure 306. The illustrated lateral support structure 306 includes an outer or bottom surface 310 that forms a generally planar face. A plurality of supporting feet 311 is coupled to the bottom surface 310. The feet 311 are spaced along the outer edges of the bottom surface 310. The feet 311 provide support and stability to the audio output device 300 such that the audio output device 300 may rest in a horizontal orientation (FIG. 17). In this position, the axis B is parallel to a support structure (e.g., a table, a bench, a floor, etc.) that supports the audio output device 300.

The illustrated audio output device 300 also includes mounting features that enable the audio output device 300 to mount to other support structures. As shown in FIG. 17, the audio output device 300 includes a slot 313 formed into the body 308. In the illustrated embodiment, the slot 313 is formed on a side of the body 308 opposite from the speaker grill 335. The slot 313 is also located adjacent the battery receptacle 324 or the second end 314 of the body 308. In other embodiments, the slot 313 may be located elsewhere on the body 308. The slot 313 is configured to receive a nail, hook, or other suitable support structure to hang the audio output device 300 from the support structure in a first vertical orientation relative to ground, as shown in FIG. 18.

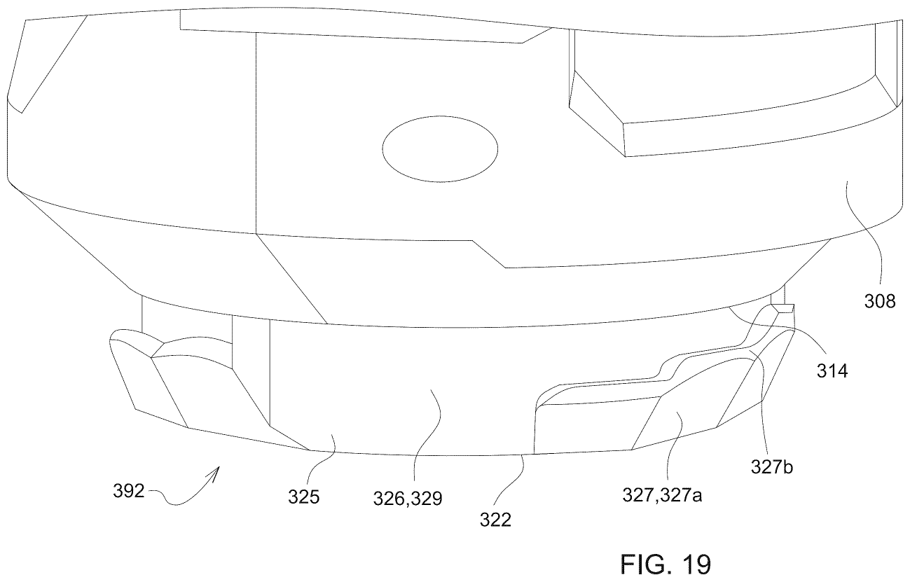

Referring to FIGS. 19 and 20, the audio output device 300 includes a puck 392 coupled to the second end 314 of the body 308. The puck 392 may house a twist lock assembly, such as any of the twist lock assemblies 188, 188a, 188b, 188c described above. Alternatively, the puck 392 may not include a twist lock assembly, similar to the puck 288 described above. In either embodiment, the puck 392 includes a base 325. The base 325 includes a bottom 322 and a sidewall 326. The bottom 322 is generally perpendicular to the axis B. The sidewall 326 is generally parallel to the axis B. The base 325 also includes a plurality of protrusions 327 extending radially outward from the base 325. In the illustrated embodiment, the base 325 includes three protrusions 327 spaced circumferentially around a circumference of the sidewall 326. Adjacent protrusions 327 are separated by a gap 329 along the sidewall 326. Each protrusion 327 comprises a plurality of flat faces or flats 327a that progressively increase upwardly in height towards the body 308. The height variances of the flats 327a define ridgelines 327b that runs along top surfaces of the protrusions 327. In the illustrated embodiment, each protrusion 327 comprises three, integrally formed flats 327a.

The base 325 is configured to be received by and engage with a receptacle 180 of the storage unit 104 (FIG. 20) to axially lock the audio output device 300 to the storage unit 104. The base 325 is aligned and inserted into the receptacle 180. When the base 325 is inserted into the receptacle 180, the projections 184 of the receptacle 180 are misaligned from the protrusions 327 of the base 325. The user may then apply a rotational force to the audio output device 300 in a first direction 331, thereby rotating the body 308 and the base 325 together such that the base is rotatably couplable to the storage unit. As the base 325 rotates in the receptacle 180, the protrusions 327 are gradually aligned with projections 184. The arrangement of the plurality of flats 327a of the protrusions 327 to form a ridgeline 327b allows for the flats 327a to engage multiple surfaces of the projections 184 to establish a firm frictional fit such that the audio output device 300 is axially secured to the storage unit 104. The user may transport the storage unit 104 to any desired location without the audio output device 300 disconnecting from the storage unit 104. Alternatively, applying a rotational force in a second direction 333 opposite the first direction 331 disengages the audio output device 300 from the storage unit 104 such that the audio output device 300 is removable from the storage unit 104.

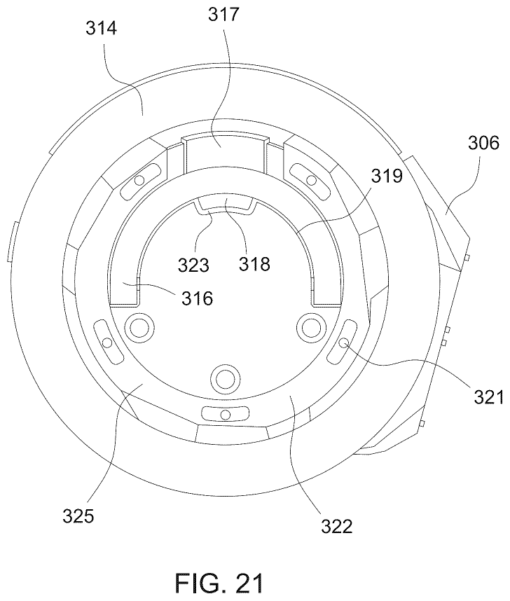

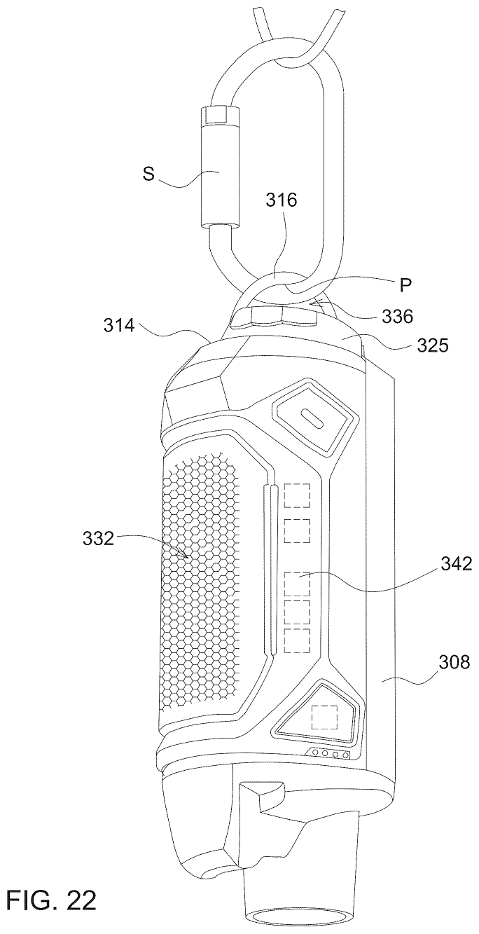

As shown in FIGS. 21 and 22, the puck 392 may include a hook 316. The hook 316 is positioned on the bottom 322 of the base 325. The illustrated hook 316 has an arcuate shape. In addition, the hook 316 is movably coupled to and movable relative to the base 325. In particular, the hook 316 is pivotably coupled to the base 325. The hook 316 is movable (e.g., pivotable) from a first or stored position (FIG. 21) to a second or extended position (FIG. 22). In the stored position, the hook 316 is received in a groove 319 formed in the base 325. In this position, the hook 316 does not extend outwardly from the bottom 322 of the base 325. As such, the audio output device 300 can be supported in the first vertical orientation relative to ground by the base 325, as shown in FIG. 15, and the hook 316 does not interfere. In the illustrated embodiment, the base 325 also includes a locking knub 317 having a tab 318 that is biased against the hook 316 to hold the hook 316 in the groove 319. The locking knub 317 is formed on the sidewall 326 within one of the gaps 329 between a pair of protrusions 327. The locking knub 317 is released when a force is applied to the tab 318 to compel the tab 318 into a cavity 323 and away from the hook 316, enabling the hook 316 to move to the extended position.

In the extended position (FIG. 22), the hook 316 extends outwardly from the bottom 322 of the base 325. In the illustrated embodiment, the hook 316 pivots from the stored position to the extended position. In particular, the hook 316 pivots about 90 degrees from the stored position to the extended position. In other embodiments, the hook 316 may linearly slide (e.g., out of and into the base 325) between the stored position and the extended position. As the hook 316 moves (e.g., pivots) from the stored position to the extended position, a void 336 is formed between the hook 316 and the base 325. A carabiner, belt hook, or other suitable support structure S can be received in the void 336 to hang the audio output device 300. The area of the void 336 is maximized when the hook 316 is in the extended position. A user may also wrap one or more fingers around the hook 316 and through the void 336 to transport the audio output device 300 to a desired location. In some embodiments, the hook 316 may hang the audio output device 300 above the ground or a support surface when coupled to the support structure S. The force of gravity acts upon the audio output device 300 such that the audio output device 300 is substantially perpendicular to the ground and positioned in a second vertical orientation relative to ground. In some embodiments, the hook 316 is not rigidly coupled to the support surface S, thus a point of contact between the support structure S and the hook 316 serves as a pivot point P about which the audio output device 300 may pivot or swing when external forces are encountered.

Referring to FIG. 21, the bottom 322 of the base 325 includes a plurality of supporting feet 321. The supporting feet 321 may contact a surface (e.g., the ground, a floor, a tabletop, etc.) to support the audio output device 300 in a vertical orientation. In the illustrated embodiment, the base 325 includes five supporting feet 321 that are circumferentially spaced along the bottom 322 of the base 325. In other embodiments, the base 325 may include fewer or more supporting feet 321.

Although the invention has been described in detail with reference to certain preferred embodiments, variations and modifications exist within the scope and spirit or one or more independent aspects of the invention as described.

Various features of the invention are set forth in the following claims.

What is claimed is:

1. A product for use with a storage unit, the product comprising:
a body;
an output element supported by the body;
a rotating disc coupled to the body for rotation therewith, the rotating disc including a first locking member; and
a base configured to engage the storage unit, the base including a second locking member;
wherein the rotating disc is movable relative to the base between an engaged position, in which the first locking member engages the second locking member such that the base rotates with the rotating disc, and a disengaged position, in which the first locking member disengages the second locking member such that the rotating disc is rotatable relative to the base.

2. The product of claim 1, wherein the base includes a first engagement feature configured to align with a second engagement feature in a receptacle of the storage unit.

3. The product of claim 2, wherein when the rotating disc is in the engaged position, the product is rotatable in a first direction to align the first engagement feature with the second engagement feature, thereby securing the base in the receptacle, and wherein when the rotating disc is in the engaged position, the product is rotatable in a second direction opposite the first direction to misalign the first engagement feature from the second engagement feature, thereby allowing the base to be removable from the receptacle.

4. The product of claim 1, wherein the first locking member includes a first plurality of teeth and the second locking member includes a second plurality of teeth configured to mesh with the first plurality of teeth.

5. The product of claim 1, wherein the first locking member includes a first material and the second locking member includes a second material, and wherein the first material engages the second material when in the engaged position to produce a frictional force between the rotating disc and the base for co-rotation.

6. The product of claim 1, further comprising an abutment plate coupled to the base by a fastener, and wherein the rotating disc abuts against the abutment plate when in the disengaged position.

7. The product of claim 1, further comprising a spring positioned between the rotating disc and the base, and wherein the spring biases the rotating disc toward the disengaged position.

8. The product of claim 1, wherein the product is a lighting device and the output element is a light-emitting diode to provide illumination to a workspace.

9. The product of claim 1, wherein the product is an audio output device and the output element is a speaker.

10. A product for use with a storage unit, the product comprising:
a body having a first end and a second end opposite the first end;
an output element supported by the body;
a base configured to engage the storage unit; and
a hook movably coupled to the base, the hook movable relative to the base between a stored position, in which the hook is received in the base, and an extended position, in which the hook extends outwardly from the base and is configured to couple to a support structure.

11. The product of claim 10, wherein the base includes a first engagement feature configured to align with a second engagement feature in a receptacle of the storage unit to secure the product in the receptacle.

12. The product of claim 11, further comprising a battery receptacle positioned at the first end of the body, and wherein the first engagement feature and the hook are both positioned on the second end of the body.

13. The product of claim 11, wherein the hook secures the product to a support structure in a first orientation relative to ground, and wherein the first engagement feature secures the product to the storage unit in a second orientation relative to ground that is different from the first orientation.

14. The product of claim 10, wherein the product is a lighting device and the output element is a light-emitting diode to provide illumination to a workspace.

15. The product of claim 10, wherein the product is an audio output device and the output element is a speaker.

16. A product for use with a storage unit, the product comprising:
a body having a first end and a second end;
a battery receptacle positioned at the first end of the body, the battery receptacle configured to receive a battery pack;
an output element supported by the body, the output element configured to be powered by the battery pack coupled to the battery receptacle; and
a base rotatably couplable to the storage unit, the base including a first engagement feature configured to align with a second engagement feature in a receptacle of the storage unit,
wherein the product is rotatable in a first direction to align the first engagement feature with the second engagement feature, thereby securing the base in the receptacle, and wherein the product is rotatable in a second direction opposite the first direction to misalign the first engagement feature from the second engagement feature, thereby allowing the base to be removable from the receptacle.

17. The product of claim 16, wherein the first engagement feature includes a plurality of protrusions extending radially outward from the base, each protrusion including a plurality of flats having progressively increasing heights that are arranged to form a ridgeline that runs along top surfaces of the protrusions.

18. The product of claim 16, wherein the product includes a hook movably coupled to the base, the hook movable relative to the base between a stored position, in which the hook is received in the base, and an extended position, in which the hook extends outwardly from the base and is configured to couple to a support structure.

19. The product of claim 16, wherein the product is a lighting device and the output element is a light-emitting diode to provide illumination to a workspace.

20. The product of claim 16, wherein the product is an audio output device and the output element is a speaker.
